(19) United States
(12) Patent Application Publication
(10) Pub. No.: US 2014/0315180 A1
(43) Pub. Date: Oct. 23, 2014

(54) AUTOMATED ESSAY EVALUATION SYSTEM

(71) Applicant: INTERNATIONAL BUSINESS MACHINES CORPORATION, Armonk, NY (US)

(72) Inventors: Edwin J. Bruce, Corinth, TX (US); Romelia H. Flores, Keller, TX (US); Akari I. Hagio, Philadelphia, PA (US); Jackson Ikhelowa, Sandy Springs, GA (US)

(73) Assignee: INTERNATIONAL BUSINESS MACHINES CORPORATION, Armonk, NY (US)

(21) Appl. No.: 13/867,320

(22) Filed: Apr. 22, 2013

(51) Int. Cl. G09B 5/00

(52) U.S. Cl. CPC G09B 5/00
USPC 434/362

(57) ABSTRACT

Automated essay evaluation includes receiving an essay in text form and determining, using a processor, curriculum data for the essay. The curriculum data includes evaluation criteria for the essay and specifies an instructor. A profile for the instructor including a writing preference for the instructor is retrieved. Using the processor, a plurality of queries for the essay can be generated according the curriculum data for the essay and the profile for the instructor. Using the processor executing an inference engine, a conclusion for each of the queries is determined according to confidence scores. The essay is scored according to the conclusions.

### BACKGROUND

Essays are routinely used to evaluate student performance. Whether within the context of a classroom or as part of a standardized test, student authored essays are used to gauge student achievement across a variety of disciplines and subjects. While the scoring process of some testing and evaluation techniques, e.g., multiple choice questions, is objective, essays evaluation is a subjective endeavor. Correctness of an essay typically is open to interpretation. The subjectivity involved translates into greater effort and time required on the part of human evaluators to properly score an essay.

A variety of different computer-based essay evaluation systems have been proposed. In many cases, the evaluation systems compare the essay under evaluation with a plurality of different model essays that have been scored by human evaluators. The essay under evaluation is assigned the same grade, or score, as the model essay to which the essay under evaluation is most closely matched. The matching techniques used vary from one evaluation system to another.

### BRIEF SUMMARY

A method includes receiving an essay in text form and determining, using a processor, curriculum data for the essay. The curriculum data includes evaluation criteria for the essay and specifies an instructor. The method includes retrieving a profile for the instructor, wherein the profile for the instructor specifies a writing preference of the instructor, and generating, using the processor, a plurality of queries for the essay according the curriculum data for the essay and the profile for the instructor. The method further includes determining, using the processor executing an inference engine, a conclusion for each of the queries according to confidence scores and scoring the essay according to the conclusions.

A system includes a processor programmed to initiate executable operations. The executable operations include receiving an essay in text form and determining curriculum data for the essay. The curriculum data includes evaluation criteria for the essay and specifies an instructor. The executable operations include retrieving a profile for the instructor, wherein the profile for the instructor specifies a writing preference of the instructor, and generating a plurality of queries for the essay according the curriculum data for the essay and the profile for the instructor. The executable operations further include determining a conclusion, using an inference engine, for each of the queries according to confidence scores and scoring the essay according to the conclusions.

A computer program product for essay evaluation includes a computer readable storage medium having program code stored thereon. The program code is executable by a processor to perform a method. The method includes receiving, using the processor, an essay in text form and determining, using the processor, curriculum data for the essay. The curriculum data includes evaluation criteria for the essay and specifies an instructor. The method also includes retrieving, using the processor, a profile for the instructor, wherein the profile for the instructor specifies a writing preference of the instructor, and generating, using the processor, a plurality of queries for the essay according the curriculum data for the essay and the profile for the instructor. The method further includes determining, using the processor executing an inference engine, a conclusion for each of the queries according to confidence scores and scoring, using the processor, the essay according to the conclusions.

### BRIEF DESCRIPTION OF THE SEVERAL VIEWS OF THE DRAWINGS

FIG. 1 is a block diagram illustrating an exemplary essay evaluation system.

FIG. 2 is a block diagram illustrating an example of a data processing system.

FIG. 3 is a message flow diagram illustrating an exemplary method of operation for the system of FIG. 1.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. The phrase “computer-readable storage medium” means a non-transitory storage medium. A computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

This specification relates to automated essay evaluation. In accordance with the inventive arrangements disclosed herein, an essay is evaluated using an inference engine. The inference engine is provided with a plurality of queries and determines a conclusion for each of the queries from an analysis of the essay. The conclusions are used as a basis for scoring the essay.

Query generation for the inference engine is performed using a variety of different information sources. Exemplary information sources can include, but are not limited to, curriculum data, instructor profiles, and/or user (student) profiles. As such, the queries applied by the inference engine to the essay under evaluation can be directed to student specific capabilities, instructor writing preferences, and/or other standardized measures of performance. Thus, unlike other systems, instructor style, preferences, characteristics, and the like can be incorporated into the evaluation of an essay. Further, since an inference engine is used, there is no need to train the evaluation system using a large number of model essays for purposes of comparison with the essay under evaluation.

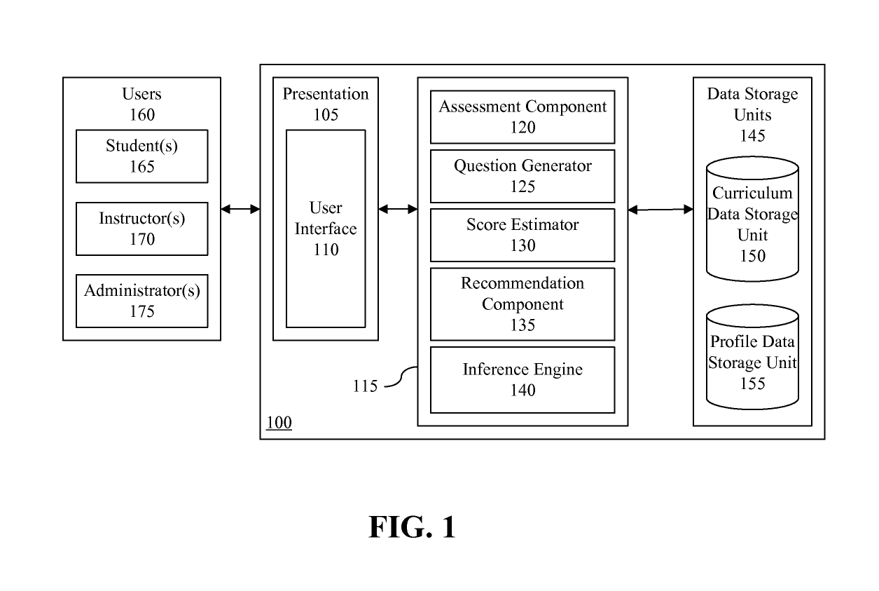

FIG. 1 is a block diagram illustrating an exemplary essay evaluation system (system) 100. As pictured, system 100 includes a presentation component 105, a plurality of evaluation components 115, and data storage units 145. Evaluation components 115 include an assessment component 120, a question generator 125, a score estimator 130, a recommendation component 135, and an inference engine 140. One or more of evaluation components 115, e.g., assessment component 120, interact with different ones of data storage units 145. Data storage units 145 include a curriculum data storage unit 150 and a profile data storage unit 155.

In one aspect, system 100 is implemented as a data processing system. In another aspect, one or more of the various components of system 100 can be implemented as one or more communicatively linked data processing systems and/or data storage nodes. For example, each component of system 100 can be implemented in a different data processing system. In another example, one or more data processing systems can include two or more components of system 100. The particular number of data processing systems used to implement system 100 is not intended as a limitation of the embodiments disclosed within this specification.

FIG. 1 illustrates a variety of exemplary users of system 100. As pictured, users 160 can include, but are not limited to, student(s) 165, instructor(s) 170, and administrator(s) 175. Users 160 interact with system 100 according to any of a variety of different use cases. For example, in one use case, a student 165 provides an essay to system 100 to receive feedback, recommendations, and a grade estimate before submitting the essay in final form to an instructor 170 for grading. In another exemplary use case, instructor 170 submits an essay authored by student 165 to system 100 for preliminary assessment and for evaluation using prescribed performance measurement standards. In another exemplary use case, student 165 submits one or more essays to system 100 to obtain a recommendation as to which instructor(s) and/or class(es) match the writing style of student 165 as determined from the submitted essay(s). In still another exemplary use case, administrator 175, e.g., a school administrator, accesses the performance and/or grading consistency of instructor 170 across a plurality of different students 165.

Presentation component 105 includes a user interface 110. In one aspect, system 100 is implemented as a Web-based system. Accordingly, user interface 110 is implemented as a Web portal or Web page. In any case, user interface 110 is configured to perform user logins, accept electronic input from users 160, and to provide electronic results, e.g., output, to users 160. Working through user interface 110, selected ones of users 160, e.g., students 165 and instructors 170, can create and maintain profiles stored within profile data storage unit 155. Selected ones of users 160, e.g., instructors 170 and/or administrators 175, can modify curriculum data within curriculum data storage unit 150.

Students 165, for example, provide essays in electronic form to system 100 through user interface 110. Instructors 170 retrieve essays from students 165 and initiate evaluation of the essays by system 100 via user interface 110. Students 165 then can retrieve results from the evaluation of their essays through user interface 110. Exemplary output provided from system 100 through user interface 110 can include a score for an essay and/or a recommendation specifying one or more suggestions for improving an essay that has been evaluated or scored. A recommendation also can provide a suggested instructor and/or course as will be described in greater detail within this specification.

Assessment component 120 coordinates operation of the various other ones of components 115. Assessment component 120 is configured to provide inputs to, and receive outputs from, other ones of evaluation components 115. Assessment component 120 further is configured to aggregate results, e.g., outputs from other ones of evaluation components 115, and return output such as recommendations, a final report, e.g., a grade or score, or the like to users 160.

Question generator 125 is configured to generate input for inference engine 140 for an essay under evaluation. Question generator 125 generates one or more queries that are provided to inference engine 140 as input. The queries are generated based upon data obtained from data storage units 145. Queries that are generated can be tailored to the student 165 submitting the essay, e.g., using the student profile, tailored to the instructor teaching the course for which the essay is submitted, e.g., using the instructor profile, and tailored to the actual course requirements or the like. In addition to generating queries, question generator 125 can store one or more standard queries that are provided to inference engine 140 along with any generated queries.

Score estimator 130 is configured to calculate a score for an essay under evaluation based upon results returned from inference engine 140. For example, in one aspect, score estimator 130 calculates a score by counting points upward from a starting score of a baseline number of points, e.g., zero points. In that case, points are awarded for elements found to be within the essay. In another aspect, however, the score can be calculated by score estimator 130 by deducting points from a baseline score, e.g., one hundred points. In that case, points are deducted from the starting score for elements that are determined to be missing from the essay under evaluation.

Inference engine 140 is configured to evaluate essays using various rules. In one aspect, inference engine 140 determines a conclusion in response to each query that is received from question generator 125. Inference engine 140, for example, generates one or more candidate conclusions for each query. Each candidate conclusion is associated with a confidence score indicating the likelihood that the candidate conclusion is correct. For each query, inference engine 140 selects the candidate conclusion having the highest confidence score as the conclusion for the query.

Recommendation component 135 is configured to provide one or more recommendations to a user based upon results determined from inference engine 140. More particularly, given the queries and/or conclusions determined by inference engine 140, recommendation component 135 determines one or more recommendations that are provided to the user.

Curriculum data storage unit 150 stores curriculum data. Curriculum data includes information that is not correlated or associated with a particular individual. In general, curriculum data includes evaluation criteria for analyzing or evaluating essays. For example, curriculum data includes one or more performance measurement standards that can be applied to one or more groups of users and/or to an individual user. The performance measurement standards are metric(s) against which conclusions and recommendations are determined. A performance measurement standard, for example, is a metric that is applicable to a plurality of different users.

For example, curriculum data can include an actual curriculum or portion thereof, lesson plans, individual progress indicators, class progress indicators, and recommendation matching criteria. In general, a “curriculum” refers to a set of one or more courses offered at an institution and the content, e.g., subjects, covered in each course. The curriculum also can indicate the depth of study for a given course or particular subject covered by that course. The curriculum further can indicate a level of understanding to be achieved in order to obtain a particular grade or score, e.g., performance measurement standards.

In some cases, the curriculum specifies all courses offered at an institution. In other cases, the curriculum specifies a limited set of prescribed courses that one must fulfill in order to pass a particular educational level such as a national standard, a particular grade level, receive a certificate, a diploma, a degree, or the like.

The curriculum, as stored within curriculum data storage unit 150, indicates the instructor that is teaching each course and, as such, is associated with the course and any assignments for the course. In cases when more than one instance (or section) of a course is offered in a given time period such as a semester, quarter, trimester, etc., the instructor for each instance of the course can be specified.

Individual progress indicators refer to metrics that define a level of performance that a student having a specified set of general characteristics, e.g., age, class placement, ranked ability, etc., should attain at a given point in time. Class progress indicators refer to metrics that define a level of performance that a group of students, e.g., an entire class or grade level, having a specified set of general characteristics, e.g., age, placement on a larger scale, etc., should attain at a given point in time.

In one aspect, assignments for a class are specified as part of the curriculum. In another aspect, assignments are specified as part of one or more lesson plans for a class as part of the curriculum data. In the context of this specification, an “assignment” refers to an essay and can define one or more objectives, aspects, or criteria that can be used for evaluating the essay. An “essay,” as used within this specification, refers to a writing of an author such as a student. The term “essay” is used generally to refer to writings and, as such, is not intended to be limiting in terms of the length of the writing, the style, or the like. For example, the term “essay” can refer to a term paper, a short story, an article, a novel, a technical paper, a research paper, a report, a legal writing, etc.

Profile data storage unit 155 stores profiles for different ones of users 160. As such, profile data storage unit 155 stores information that is user-specific. The profiles include profiles for students 165 (i.e., student profiles) and profiles for instructors 170 (i.e., instructor profiles). A student profile includes one or more performance measurements that are specific to the user, in this case a student. For example, a student profile can include information indicating classes that have been taken by the student, classes in which the student is enrolled, grades for classes, assignments for classes, class rank, etc.

An instructor profile can include, for example, instructor-specific criteria such as writing preferences or the like. A writing preference is one or more attributes or rules defining a writing style, one or more writing traits, literary mechanisms, or the like, as preferred by the instructor. In one aspect, one or more writing preferences can be specified collectively within a profile by specifying a literary figure (e.g., an author or journalist) preferred by the user associated with the profile. For example, one or more well-known literary figures can be characterized in that each literary figure is associated with one or more predetermined writing preferences. Accordingly, as part of a profile for instructor 170 (or a student 165), a literary figure can be listed which indicates one or more writing preferences that are preferred by the user associated with the profile.

System 100 supports a variety of different types or methods of operation. For example, system 100 can provide constructive feedback and recommendations on writing assignments in order to improve skills and earn higher grades. System 100 can be used by instructor 170 and/or administrator 175 to quickly and more consistently evaluate essays in order to provide valuable feedback and enable rapid grade returns. System 100 can be customized to emphasize the importance, e.g., through queries and scoring, of specific aspects of an essay and to provide particular feedback or recommendations. For example, regarding recommendations, the recommendation matching data can be modified, e.g., by an instructor, to provide desired recommendations responsive to particular results from inference engine 140.

On a larger scale, system 100 can be utilized to determine effectiveness of scoring for larger student groups such as an entire school, school district, or region against prescribed standards. As noted, the use of student and/or instructor profiles allows system 100 to provide enhanced scoring or assessments in that the student's expected level of performance can be considered. Further, any particular preferences or areas of emphasis for an assignment, as determined by the instructor, through the curriculum data and/or the instructor profile also are considered.

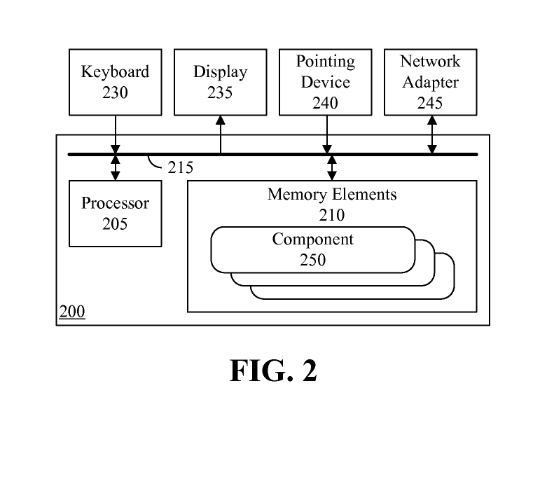

FIG. 2 is a block diagram illustrating an example of a data processing system 200. Data processing system 200 is an exemplary system that implements one or more components of system 100 of FIG. 1.

As shown, system 200 includes one or more processors (e.g., central processing units) 205 coupled to memory elements 210 through a system bus 215 or other suitable circuitry. System 200 can store program code within memory elements 210 in the form of one or more components 250. Processor 205 executes the program code accessed from memory elements 210 via system bus 215 or the other suitable circuitry. In one aspect, system 200 is implemented as a computer or other programmable data processing apparatus that is suitable for storing and/or executing program code. It should be appreciated, however, that system 200 can be implemented in the form of any system including a processor and memory that is capable of performing and/or initiating the functions and/or operations described within this specification.

Memory elements 210 include one or more physical memory devices such as, for example, local memory and one or more bulk storage devices. Local memory refers to RAM or other non-persistent memory device(s) generally used during actual execution of the program code. Bulk storage device(s) are implemented as a hard disk drive (HDD), solid state drive (SSD), or other persistent data storage device. System 200 also can include one or more cache memories (not shown) that provide temporary storage of at least some program code in order to reduce the number of times program code must be retrieved from a bulk storage device during execution.

Input/output (I/O) devices such as a keyboard 230, a display 235, and a pointing device 240 optionally can be coupled to system 200. The I/O devices can be coupled to system 200 either directly or through intervening I/O controllers. One or more network adapters 245 also can be coupled to system 200 to enable system 200 to become coupled to other systems, computer systems, remote printers, and/or remote storage devices through intervening private or public networks. Modems, cable modems, wireless transceivers, and Ethernet cards are examples of different types of network adapters 245 that can be used with system 200.

As pictured in FIG. 2, memory elements 210 store one or more components 250. Components 250, being implemented in the form of executable program code, are executed by system 200 and, as such, are considered an integrated part of system 200. Each of components 250, for example, represents a component of system 100 of FIG. 1. Any data items that are utilized by components 250 (i.e., system 100) in evaluating an essay, e.g., curriculum data, a student profile, instructor profile(s), are functional data structures that impart functionality when employed as part of system 200.

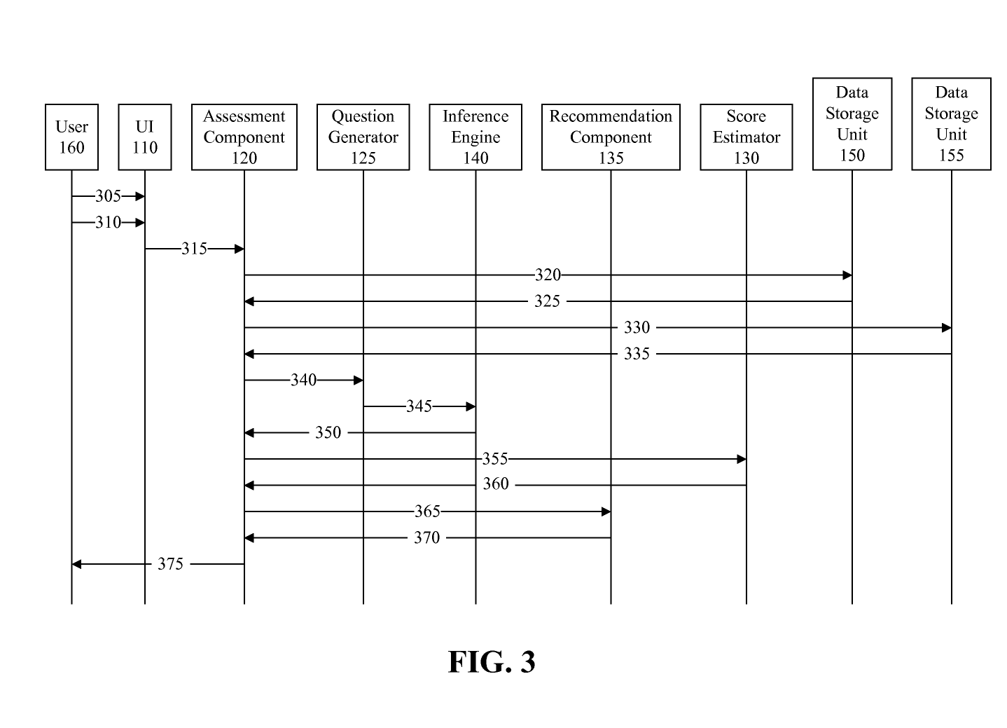

FIG. 3 is a message flow diagram illustrating an exemplary method of operation for system 100 of FIG. 1. FIG. 3 illustrates the interaction that occurs among the various components of system 100 responsive to a received input. For purposes of illustration, user 160 is a student. The message flows illustrated in FIG. 3 begin in a state where user 160 has previously created a profile within system 100. The profile includes information such as current classes, instructors for the classes, and the like. Further, instructor(s) of user 160 also have created a profile and updated curriculum data as desired.

Accordingly, the message flow diagram of FIG. 3 begins with user 160 initiating a login operation 305 into system 100. For example, the user provides identifying information to user interface (shown as “UI” in FIG. 3) 110, e.g., a Web-based user interface. System 100, via user interface 110, can log user 160 in to access functions of system 100.

After successfully logging user 160 into system 100, user interface 110 receives a user input 310. For example, user 160 submits an essay to system 100, which is received by user interface 110. The essay can be specified in text form, e.g., as digitized text. In one aspect, user 160, as part of the submission process for the essay, indicates the particular assignment for which the essay is being submitted as part of user input 310. It should be appreciated that any other identifying information can be provided with the essay in addition to, or in lieu of, the assignment so that the related curriculum data for the essay can be located by system 100. The essay submitted by user 160 for evaluation is also referred to herein as the “essay under evaluation.”

User interface 110 provides the essay, the assignment indication (and/or other information), and the user identifying information received from user 160 to assessment component 120 as part of transaction 315. Responsive to transaction 315, assessment component 120 sends a request 320 to data storage unit 150. Request 320 requests curriculum data relating to the essay. For example, the assignment indicator can be used to retrieve curriculum data for the essay.

Responsive to request 320, data storage unit 150 sends reply 325 to assessment component 120. Reply 325 includes the requested curriculum data. In one aspect, reply 325 can include performance measurement standards for the assignment. For example, reply 325, in the form of curriculum data, can include instructor-defined guidelines for the assignment that are to be followed, the instructor for the class for which the essay is being submitted, other class-specific information, recommendation matching criteria for the essay under evaluation, and any other criteria that is specific to the assignment as identified by user 160.

Assessment component 120 sends a request 330 to data storage unit 155. Request 330 requests profile information for user 160 and the instructor associated with the course for which the essay under evaluation has been submitted. More particularly, assessment component 120 requests the profile for user 160 and the profile for the instructor teaching the course for which the essay under evaluation assignment has been given. Responsive to request 330, data storage unit 155 sends reply 335 to assessment component 120. Reply 335 includes the profile for user 160 and the profile for the instructor. As discussed, the profile for the instructor includes information including, but not limited to, writing style preferences of the instructor, assessment patterns of the instructor, writing propensities of the instructor, and the like.

Assessment component 120 provides the collected data to question generator 125 as part of transaction 340. More particularly, assessment component 120 sends the student profile, the instructor profile, the curriculum data, and the essay under evaluation to question generator 125. As previously discussed, question generator 125 determines, or generates, one or more queries based upon the curriculum data, the profile of user 160, and the profile of the instructor. Question generator 125 further generates, or selects if previously created and stored, one or more standard queries for the essay under evaluation in order to assess universal attributes of the essay under evaluation including, for example, appropriate diction, figures of speech, consistency in person and tense, accuracy of presented information, references to other sources, relevant quotes, etc.

As an example, consider the case in which the instructor is partial to varied syntax within an essay. Such a preference can be enforced through generation of queries such as those outlined below.
How many sentences begin with the same word and/or phrase?
Does the sentence structure vary?
Is there a sufficient balance between long and short sentences?
Is vocabulary and terminology being utilized that is appropriate to the student's proficiency level?
   The queries shown above are derived from both the instructor's profile and the student's profile.

As another example, consider the case in which a student aspires to be in tune, e.g., similar to or mimic, the instructor's demonstrated writing preferences relating to style, terminology, and phrase usage. The student submits an essay for evaluation. Question generator 125 aids in evaluating the essay submitted by the student by applying known patterns emanating from the instructor profile in order to evaluate the degree to which the student has successfully emulated the writing preferences of the instructor.

Continuing with FIG. 3, question generator 125, having generated and/or selected the necessary queries, provides the queries and the essay to inference engine 140 as part of transaction 345.

Responsive to transaction 345, inference engine 140 determines a conclusion, or answer, for each query submitted from question generator 125 for the essay under evaluation. As discussed, inference engine 140 typically determines more than one conclusion for each query. Each of the plurality of conclusions determined is considered a candidate conclusion. Each candidate conclusion is associated with a confident score indicating the likelihood that the candidate conclusion is correct. For each query, inference engine 140 selects the candidate conclusion with the confidence score indicating the highest probability of being correct for that query. Inference engine 140 sends the conclusions determined for the essay under evaluation to assessment component 120 as part of transaction 350.

Assessment component 120 sends a request 355 for scoring to score estimator 130. Request 355 can include, or specify, results generated by inference engine 140, e.g., the conclusions and the corresponding queries. Score estimator 130 calculates a score, or estimate thereof, for the essay under evaluation based upon the received conclusions.

In one aspect, each conclusion can be associated with a point value. The point values can vary in accordance with the importance of the conclusion of the query for scoring. In another aspect, a weighting factor can be applied to the point value of the query and/or conclusion. In any case, the number of points associated with each conclusion can be varied, for example, according to instructor preference.

Score estimator 130 calculates an estimate of the score for the essay under evaluation based upon the conclusions drawn and the number of points associated with, or available for, each conclusion. Thus, score estimator 130 adds points to a baseline score in the case where points are awarded for attributes possessed by the essay and subtracts points from a baseline score in the case where points are deducted for attributes found lacking in the essay. Score estimator 130 sends reply 360 to assessment component 120. Reply 360 includes the score for the essay under evaluation.

Assessment component 120 sends a request 365 to recommendation component 135. Request 365 requests feedback from recommendation component 135 for improving the essay under evaluation. For example, as part of request 365, assessment component 120 can send the conclusions generated by inference engine 140. The query for each conclusion also can be provided as part of request 365. Request 365 further can specify recommendation matching criteria previously retrieved as part of the curriculum data from data storage unit 150.

Recommendation component 135 determines the appropriate feedback from data included in request 365. In one aspect, recommendation component 135 can include, or access, a recommendation data store, e.g., a database. In that case, recommendation component 135 fetches one or more recommendations from the data store that conform to the recommendation matching criteria when compared with the results from inference engine 140. Recommendation component 135 then sends a recommendation 370 including the feedback to assessment component 120.

As an example, consider the case in which inference engine 140 determines the following conclusions for the queries listed below.
Are other works cited to substantiate the argument? No
Are there relevant quotes in support of the argument? No
Are there examples that strengthen the argument? No
   Given the foregoing conclusions for the queries, recommendation component 135 could provide a recommendation such as “Consider developing this point further and supporting your argument with outside sources, quotes, and examples.” Assessment component 120 sends the score and recommendation 375 to user 160 through user interface 110.

The embodiments described within this specification provide a flexible and automated essay evaluation system. The use of inference engine 140 and confidence scores in determining conclusions allows system 100 to determine what is correct, more correct, or preferred with regard to an essay under evaluation. Further, the embodiments disclosed herein do not rely upon the general assumption that a high quality essay must resemble other high quality essays, whether sample “gold standard” essays, templates, or the like.

Because queries are generated from the curriculum and profile data, the queries and, as such, the analysis performed by the inference engine 140, can be directed to any desired aspects of essay writing such as creativity or the like. By updating the curriculum and/or profile data, the queries and analysis performed by the inference engine 140 can be updated or modified. Further, the scoring can be updated by adjusting the points awarded or taken away for particular query/conclusion combinations when scoring so that the query and corresponding conclusion influence the score by the desired amount.

By avoiding comparisons between essays under evaluation and model essays, less data is needed for operation. For example, system 100 need not be “trained” using model essays. As such, system 100 can be used across multiple subject areas and disciplines by updating or changing the curriculum and/or profile data without having to re-train using model essays directed to new or different subject matter. The use of curriculum data and incorporation of student and/or instructor profiles allows the scoring, through query generation, to be tailored to the subject matter of the essay, the abilities of an individual essay writer, and/or the preferences of the instructor.

In another aspect, system 100 can be configured to provide instructor recommendations. In cases where a student has a choice among two or more different instructors, system 100 can be used to pair students with instructors based upon an evaluation of the student's writing. In illustration, system 100 can receive one or more essays from the student seeking an instructor recommendation. If the instructors are being considered for a particular class, system 100 can retrieve curriculum data for each of the instructors being considered. The profile of each instructor also can be retrieved.

System 100 generates a set of queries for evaluating the essay for each different instructor under consideration. Conclusions for each query can be determined. For each instructor-specific set of queries and corresponding conclusions, the essay can be scored. As such, the essay, or essays as the case may be, receives a score for each instructor. System 100 can provide a recommendation to the student indicating the instructor that, given the curriculum data and instructor profile(s), resulted in the most favorable score for the essay(s). In one example, the recommendation can be a list of instructors and corresponding scores for the essay(s). The recommendation provides the student with information that attempts to match students with instructors according to compatible writing styles and/or preferences.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the figures may occur out of the order shown or described. For example, two blocks or transactions shown in succession may, in fact, be executed substantially concurrently, or the blocks or transactions may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method, comprising:
receiving an essay in text form;
determining, using a processor, curriculum data for the essay, wherein the curriculum data comprises evaluation criteria for the essay and specifies an instructor;
retrieving a profile for the instructor, wherein the profile for the instructor comprises a writing preference of the instructor;
generating, using the processor, a plurality of queries for the essay according the curriculum data for the essay and the profile for the instructor;
determining, using the processor executing an inference engine, a conclusion for each of the queries according to confidence scores; and
scoring the essay according to the conclusions.

2. The method of claim 1, further comprising:
receiving identifying information for a user having authored the essay; and
retrieving a profile for the user using the identifying information, wherein the profile for the user comprises a performance measurement specific to the user;
wherein the plurality of queries are further generated according to the profile for the user.

3. The method of claim 2, wherein the curriculum data comprises recommendation matching data, the method further comprising:
determining a recommendation for the user according to a comparison of the conclusions with the recommendation matching data.

4. The method of claim 1, wherein the curriculum data comprises a performance measurement standard applicable to a plurality of different users against which the essay is evaluated.

5. The method of claim 4, wherein the wherein the performance measurement standard is specified by the instructor.

6. The method of claim 1, further comprising:
providing a plurality of standard queries to the inference engine, wherein each standard query is independent of an identity of the author of the essay and the instructor.

7. The method of claim 1, wherein the curriculum data specifies a plurality of different instructors for the essay;
wherein retrieving a profile for the instructor comprises retrieving a profile for each of the plurality of instructors;
wherein generating, using the processor, a plurality of queries according the curriculum data for the essay and the profile for the instructor generates a query using each profile for the plurality of instructors;
wherein scoring the essay according to the conclusions comprises scoring the essay for each of the plurality of instructors; and
wherein the method further comprises providing an instructor recommendation according to the scoring.

8. A system comprising:
a processor programmed to initiate executable operations comprising:
receiving an essay in text form;
determining curriculum data for the essay, wherein the curriculum data comprises evaluation criteria for the essay and specifies an instructor;
retrieving a profile for the instructor, wherein the profile for the instructor comprises a writing preference of the instructor;
generating a plurality of queries for the essay according the curriculum data for the essay and the profile for the instructor;
determining a conclusion, using an inference engine, for each of the queries according to confidence scores; and
scoring the essay according to the conclusions.

9. The system of claim 8, wherein the processor is further programmed to initiate executable operations comprising:
receiving identifying information for a user having authored the essay; and
retrieving a profile for the user using the identifying information, wherein the profile for the user comprises a performance measurement specific to the user;
wherein the plurality of queries are further generated according to the profile for the user.

10. The system of claim 9, wherein the curriculum data comprises recommendation matching data, and wherein the processor is further programmed to initiate an executable operation comprising:
determining a recommendation for the user according to a comparison of the conclusions with the recommendation matching data.

11. The system of claim 8, wherein the curriculum data comprises a performance measurement standard applicable to a plurality of different users against which the essay is evaluated.

12. The system of claim 11, wherein the wherein the performance measurement standard is specified by the instructor.

13. The system of claim 8, wherein the processor is further programmed to initiate an executable operation comprising:
providing a plurality of standard queries to the inference engine, wherein each standard query is independent of an identity of the author of the essay and the instructor.

14. The system of claim 8, wherein the curriculum data specifies a plurality of different instructors for the essay;
wherein retrieving a profile for the instructor comprises retrieving a profile for each of the plurality of instructors;
wherein generating a plurality of queries according the curriculum data for the essay and the profile for the instructor generates a query using each profile for the plurality of instructors;
wherein scoring the essay according to the conclusions comprises scoring the essay for each of the plurality of instructors; and
wherein the processor is further programmed to initiate an executable operation comprising providing an instructor recommendation according to the scoring.

15. A computer program product for essay evaluation, the computer program product comprising a computer readable storage medium having program code stored thereon, the program code executable by a processor to perform a method comprising:
receiving, using the processor, an essay in text form;
determining, using the processor, curriculum data for the essay, wherein the curriculum data comprises evaluation criteria for the essay and specifies an instructor;
retrieving, using the processor, a profile for the instructor, wherein the profile for the instructor comprises a writing preference of the instructor;
generating, using the processor, a plurality of queries for the essay according the curriculum data for the essay and the profile for the instructor;
determining, using the processor executing an inference engine, a conclusion for each of the queries according to confidence scores; and
scoring, using the processor, the essay according to the conclusions.

16. The computer program product of claim 15, wherein the method further comprises:
receiving identifying information for a user having authored the essay; and
retrieving a profile for the user using the identifying information, wherein the profile for the user comprises a performance measurement specific to the user;
wherein the plurality of queries are further generated according to the profile for the user.

17. The computer program product of claim 16, wherein the curriculum data comprises recommendation matching data, the method further comprising:
determining a recommendation for the user according to a comparison of the conclusions with the recommendation matching data.

18. The computer program product of claim 15, wherein the curriculum data comprises a performance measurement standard applicable to a plurality of different users against which the essay is evaluated.

19. The computer program product of claim 15, wherein the method further comprises:
providing a plurality of standard queries to the inference engine, wherein each standard query is independent of an identity of the author of the essay and the instructor.

20. The computer program product of claim 15, wherein the curriculum data specifies a plurality of different instructors for the essay;
wherein retrieving a profile for the instructor comprises retrieving a profile for each of the plurality of instructors;
wherein generating, using the processor, a plurality of queries according the curriculum data for the essay and the profile for the instructor generates a query using each profile for the plurality of instructors;
wherein scoring the essay according to the conclusions comprises scoring the essay for each of the plurality of instructors; and
wherein the method further comprises providing an instructor recommendation according to the scoring.
